(19) United States
(12) Patent Application Publication
(10) Pub. No.: US 2009/0228256 A1
(43) Pub. Date: Sep. 10, 2009

(54) Method and system of graphical simulation of thin shell objects

(76) Inventors: MIN GYU CHOI, Seoul (KR); Seung Yong Woo, Seoul (KR); Hyeong-Seok Ko, Seoul (KR)

Correspondence Address: PARK LAW FIRM, 3255 WILSHIRE BLVD, SUITE 1110, LOS ANGELES, CA, 90010, US

(21) Appl. No.: 12/045,429

(22) Filed: Mar. 10, 2008

(51) Int. Cl. G06G 7/48

(52) U.S. Cl. 703/7

(57) ABSTRACT

A real-time simulation method for thin shells undergoing large deformation is provided. Shells are thin objects such as leaves and papers that can be abstracted as 2D structures. Development of a satisfactory physical model that runs in real-time but produces visually convincing animation of thin shells has been remaining a challenge in computer graphics. For real-time integration of the governing equation, a modal warping method for shells is developed. This new simulation framework results from making extensions to the original modal warping which was developed for the simulation of 3D solids.

### BACKGROUND OF THE INVENTION

The present invention relates to a method and system of graphical simulation of thin shell objects. More particularly, this invention relates to a method and system of real-time graphical simulation of thin shell objects using a modal warping for shells.

### INTRODUCTION

Thin flexible objects such as leaves or papers often appear in computer graphics scenes. Non-zero structural thickness is a factor that influences their dynamic movements. Nevertheless, those objects are often abstracted as two-dimensional (2D) entities, regarding the rest as visual details. Thin flexible objects which can be abstracted as 2D entities as thin shells. The invention relates physically-based simulation of thin shells.

Simulation of 3D solids has been studied by the graphics academic community. Since thin shells are special cases of 3D solids, one may apply the techniques developed for 3D solids to the simulation of thin shells. Unfortunately, this approach does not produce satisfactory results; Modeling thin shells as 3D elastic solids requires very fine FEM meshes to correctly capture the global bending behavior.

There is a different approach to simulating shells, namely, representing shells as 2D meshes rather than 3D solids. However, accurate modeling and simulation of a thin shell structure with a moderately-sized 2D mesh requires one of the most complex formulations in continuum mechanics, shell theory.

The invention discloses a real-time simulation technique for thin shells undergoing large rotational deformation. Even though the present work represents a shell with a 2D mesh, it does not derive the governing equation from shell theory, but from a simpler model. In the computer graphics field, dynamics of thin shells by resorting to a discrete model instead of Cosserat models that are normally employed in shell theory. The resulting governing equation of takes the same form as that of 3D solids, which makes it easy to understand and implement. However, any particular step to make time-integration of the equation run in real-time is not taken.

Meanwhile, another technique called modal warping simulates large rotational deformation of 3D elastic solids in real-time. But it was not intended for thin shells. On the other hand, a real-time technique that can simulate thin shells was suggested, but the technique could not be used for simulating large rotational deformations.

The invention is based on the discrete shells and the modal warping technique; adopting the dynamic formulation, the present invention develops a new simulation framework for thin shells that runs in real-time by extending the modal warping technique.

Accordingly, a need for the invention has been present for a long time. This invention is directed to solve these problems and satisfy the long-felt need.

### SUMMARY OF THE INVENTION

The present invention contrives to solve the disadvantages of the prior art.

An objective of the invention is to provide a method and system of graphical simulation of thin shell objects.

Another objective of the invention is to provide a method and system of real-time graphical simulation of thin shell objects using modal warping for thin shell with acceptable realism.

An aspect of the invention provide a method of simulation of a two-dimensional object, which comprises: providing information of motions of the two-dimensional object for which a graphical simulation is to be performed, wherein the object is represented by a 2-manifold triangular mesh including a plurality of nodes, wherein each of the plurality of nodes makes a displacement for a given time as the object experiences a deformation, wherein the displacement of each node is composed of a rotation of a local coordinate system and a local displacement of said node in the local coordinate system, wherein the local displacement defines a deviation of said node from a trajectory of the rotation of the local coordinate system; obtaining a modal amplitude of said node in the local coordinate for the given time, wherein the modal amplitude represents the local displacement in a modal space, in which the deformation of the object is described in terms of characteristic deformations (mode shape) in natural frequencies; obtaining a rotational vector of the local coordinate system by tracking orientation of the local coordinate frame associated with said node; and obtaining the displacement of said node for the given time using the rotational vector and the modal amplitude.

The object may comprise a thin flexible object, and providing may comprise mapping a plurality of positions of the object with the plurality of nodes.

Each of the plurality of nodes may have an equation of motion thereof, and the equation of motion of each node may be at least partially interdependent on motions of neighboring nodes, whereby equations of motion of the plurality of nodes form a group of equations.

The obtaining the modal amplitude may comprise solving the group of equations.

The group of equations may be adapted for a finite element model computation.

Motion of said node may be represented by a first equation of Mü(t)+C\dot{u}(t)+Ku(t)=F(t) wherein u(t) represents a displacement of said node, where M represents a mass of a portion of the object represented by said node, where C represents damping characteristics of said node, where K represents stiffness characteristics of said node, and where F represents external forces exerted to said node. The displacement u(t) may be represented using the modal amplitude and a modal displacement matrix associated with the first equation in the equation of u(t)=Φq(t), where Φ is the modal displacement matrix, and where q(t) is the modal amplitude of said node in the local coordinate system. The first motion equation may be converted to a second motion equation representing the motion of said node using the modal amplitude.

The rotational vector may be obtained using a global matrix of rotation and a modal displacement matrix associated with a group of equations representing motions of the plurality of nodes. The global matrix of rotation may represent rotations of the plurality of nodes, and each column of the modal displacement matrix may represent a corresponding mode shape.

The rotation vector may be obtained using the formula w(t)=WΦq(t), where W is the global matrix of rotation, Φ is the modal displacement matrix, and q(t) is the modal amplitude of said node in the local coordinate system.

The global matrix of rotation, W, may be obtained based on Jacobian of orientation of a triangle defined by said node and neighboring nodes. The orientation of the triangle may be obtained by a solution to

$$arg {min}_{{ω}_{A}} {\sum }_{i = 1}^{3} ‖ {( {R}_{A} ( {x}_{i} - {x}_{cm} ) - ( {a}_{i} - {a}_{cm} ) ‖}^{2} ,$$

where xᵢ represent the vertices in a undeformed state, aᵢ represent the position of the vertices after deformation, R_{A} is the 3×3 rotation matrix,

$${x}_{cm} = \frac{1}{3} {\sum }_{\underline{i}} {x}_{i} , and {a}_{cm} = \frac{1}{3} {\sum }_{\underline{i}} a .$$

The modal displacement matrix may be obtained by solving an eigenvalue problem for the group of equations.

The obtaining the rotation vector may comprise obtaining a rotation vector of a triangle before and after deformation defined by three nodes. The obtaining the rotation vector may comprise taking average of rotation vectors of a plurality of triangles sharing said node.

The method may further comprise obtaining the local displacement of said node in the local coordinate system using the modal amplitude.

The obtaining the displacement of said node for the given time may comprise adding the local displacement to the rotation vector of the local coordinate system.

The displacement of said node for the given time may be represented by an equation, u=\tilde{R}Φq, where u is the displacement of said node for the given time,

$$\tilde{R} is \frac{1}{t} {\int }_{0}^{t} R ( t ) d t ,$$

q is the modal amplitude of said node in the local coordinate, and Φ is a modal displacement matrix associated with a group of equations representing motions of the plurality of nodes, and each column of the modal displacement matrix may represent a corresponding mode shape.

The obtaining the displacement of said node may comprise integrating computation using the equation of

$$u = {\int }_{0}^{t} R ( t ) Φ \dot{q} ( t ) d t ,$$

where R(t) represents an orientation of a local coordinate of each node at time t, q is the modal amplitude of said node in the local coordinate, and Φ is a modal displacement matrix associated with a group of equations representing motions of the plurality of nodes, and each column of the modal displacement matrix may represent a corresponding mode shape.

The advantages of the present invention are: (1) the invention simulates a thin shell object with acceptable realism; and (2) the method and system of the invention uses a modal warping for thin shells to simulate a thin shell object with acceptable realism in real-time.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram illustrating a dihedral angle of an edge in the undeformed and the deformed states;

FIG. 2 is a schematic diagram illustrating finding the rotational component ω̅_{A}(u_{A}) of a triangle, the deformation of which is given with u_{A}=[u₁^{T}|u₁^{T}|u₁^{T}]^{T};

FIG. 3 is a computer graphics illustrating a real-time deformation of a large mesh;

FIG. 4 is a diagram illustrating a simulation of flat and V-beams deforming in the gravity field;

FIG. 5 is a diagram illustrating a V-beam deformed by linear modal analysis, by modal warping for thin shells, and by discrete shells under gravities of different magnitudes;

FIG. 6 shows graphs illustrating an error analysis of the V-beam shown in FIG. 5, (a) the relative L2 displacement field error, and (b) the area change with respect to the initial area;

FIG. 7 is a diagram illustrating a flat beam manipulated with a position constraint (left), with an orientation constraint (middle), and with both position and orientation constraints (right); and

FIG. 8 is a diagram illustrating a constraint-driven animation of a character consisting of four thin shells (the hat, body, and two legs).

### DETAILED DESCRIPTION OF EMBODIMENTS OF THE INVENTION

The U.S. patent application Ser. No. 11/318,158 filed on Dec. 23, 2005 by the applicants is incorporated by reference into this disclosure as if fully set forth herein.

Dynamics of Thin Shell

We use a 2-manifold triangular mesh to represent the shell, and formulate its dynamics with nonlinear membrane and flexure energy functions that measure the differences between the undeformed and the deformed states of the mesh. The energy functions that appear in this section are adopted from prior arts. We note that, in fact, the simulation framework in embodiments of the invention does not depend on the energy functions being used.

Membrane Energy

The membrane energy models the shell resisting on intrinsic deformations, and consists of stretch and shear energies. For the stretch energy, we use the triangle-based function that sums up changes in the area

$${E}_{A} \dot{=} {\sum }_{A} \frac{{( ‖ A ‖ - ‖ \overline{A} ‖ )}^{2}}{‖ \overline{A} ‖} , \qquad ( 1 )$$

where ∥A∥ and ∥Ā∥ are the areas of the triangle A in the deformed and the undeformed states, respectively.
For the shear energy, we use the edge-based function that sums up changes in the length

$${E}_{L} \dot{=} {\sum }_{e} \frac{{( ‖ e ‖ - ‖ \overline{e} ‖ )}^{2}}{‖ e ‖} , \qquad ( 2 )$$

where ∥e∥ and ∥ē∥ are the lengths of the edge e in the deformed and the undeformed states, respectively.

Flexural Energy

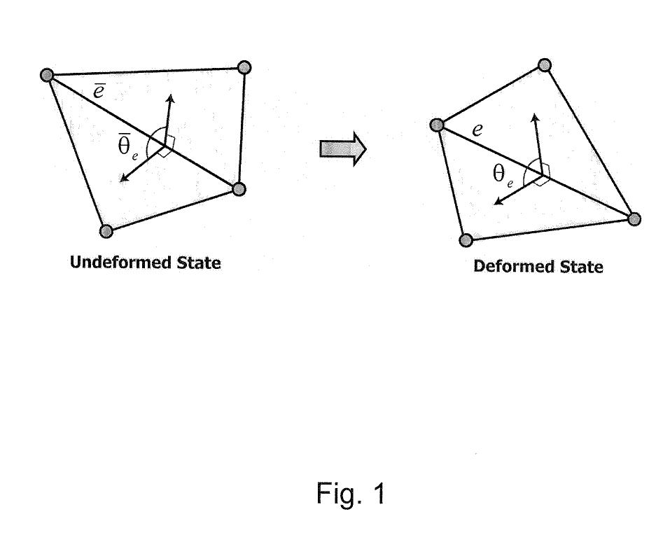

For measuring the flexural energy of the shell, we use the function,

$${E}_{B} \dot{=} {\sum }_{A} 3 ( {θ}_{e} - {\overline{θ}}_{e} ) \frac{‖ e ‖}{{\overline{h}}_{e}} , \qquad ( 3 )$$

where θₑ and θ̅ₑ are the dihedral angles of the edge e measured in the deformed and the undeformed states, respectively, and h̅ₑ is the average of the heights of the two triangles sharing the edge e in the undeformed state (See FIG. 1). This energy function was obtained by integrating the squared difference of mean curvature at a point over the piecewise linear mesh of the shell, and then by discretizing the integral.

Governing Equation

The total elastic energy of a thin shell is then defined by the sum of the membrane and flexural energies

E\hat{=}k_{A}E_{A}+k_{L}E_{L}+k_{B}E_{B}, (4)

where k_{A}, k_{L}, and k_{B} are the material constants that represent the stretch, shear, and flexural stiffness, respectively. Differentiating the above energy function with respect to the displacements of the mesh nodes gives the generalized elastic force due to the elastic potential energy, which can be written in the form

$$\frac{\partial E ( u )}{\partial u} = K ( u ) u , \qquad ( 5 )$$

where u(t) is a 3n-dimensional vector that represents the displacements of the n nodes from their original positions. Then, the governing equation that describes the dynamic movements of a thin shell can be written as

Mü+C\dot{u}+Ku=F, (6)

where M and C are the mass and damping matrices, respectively, and F(t) is a 3n-dimensional vector that represents the external forces acting on the n nodes. Here, the elastic force term K(u)u is nonlinear with respect to u. Therefore real-time integration of Equation (6) is a nontrivial task.

Modal Warping for Shells

For real-time simulation of thin shells, we adopt the modal warping framework. Since the procedure is for 3D solids, we have to make modifications to make it applicable to shells. A major modification is done to the method to keep track of the orientation of the local coordinate frames associated with the mesh nodes, which is presented in Section 3.2.

Modal Displacements

When there is a small rotational deformation, the generalized elastic force K(u)u appearing in Equation (6) can be linearly approximated as Ku for a constant matrix K. When this simplification is applicable, we can decouple Equation (6) by solving the generalized eigenvalue problem KΦ=MΦΛ and finding Φ and Λ such that Φ^{T}MΦ=I and Φ^{T}KΦ=Λ. Since the columns of F form a basis of the 3n-dimensional space, u can be expressed as a linear combination of the columns:

u(t)=Φq(t). (7)

Here, Φ is the modal displacement matrix, of which the i-th column represents the i-th mode shape, and q(t) is a vector containing the corresponding modal amplitudes as its components. By examining the eigenvalues we can take only the m dominant columns of Φ, significantly reducing the amount of computation. In the following, Φ denotes the 3n×m submatrix formed by this procedure. Substitution of Equation (7) into Equation (6) followed by a premultiplication of Φ^{T} decouples Equation (6) as

M_{q}\ddot{q}+C_{q}\dot{q}+K_{q}q=Φ^{T}F, (8)

where M_{q}=I, C_{q}=(ξI+ξΛ), and K_{q}=Λ are now all diagonal, and Φ^{T}F is the modal force. The decoupling shown in Equation (8) brings a tremendous speed-up in the numerical computation. The essence of modal warping technique is to decompose a large deformation into a series of small deformations for which the above decoupling procedure can apply to; The details are presented in Section 3.3.

Modal Rotations

To develop a modal warping technique for thin shells, we must develop a procedure to represent the rotational component of deformation in terms of q(t). More specifically, we need an equation of a similar form as Equation (7), but this time for w(t), the 3n-dimensional vector formed by concatenating all the 3D rotation vectors of the mesh nodes. In the case of 3D solids, the curl ½∇×u gives the rotational component of the deformation. However, this curl-based rotation capturing is not applicable to a shell because the differentiation involved in the curl operation should not be done over free 3D space but be restricted to the 2D domain occupied by the shell.

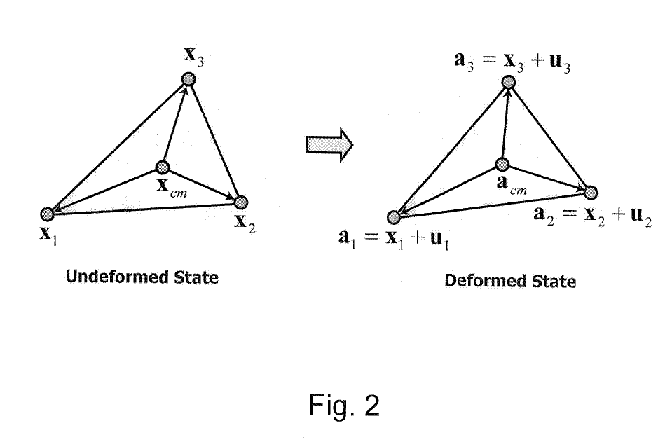

In this section, we develop a novel procedure to calculate the rotational component of deformation. It is based on the Jacobian of triangle orientation. Imagine a triangle labeled A undergoes the deformation shown in FIG. 2, in which xᵢ represent the vertices in the undeformed state, uᵢ represent the displacements occurred, and aᵢ represent the position of the vertices after the deformation. Let ω_{A} be the 3D rotation vector that represents the orientational change occurred to A by this deformation; ω_{A} encodes the rotation that is made around the unit axis ω_{A}/∥ω_{A}∥ by the angle ∥ω_{A}∥. This rotation vector must be a purely geometric function ω_{A}(u_{A}) of the displacements of the three triangle nodes, u_{A}=[u₁^{T}|u₁^{T}|u₁^{T}].

The problem of finding the rotation occurred to the triangle shown in FIG. 2 can be formulated as:

$$\text{arg} {min}_{{ω}_{A}} {\sum }_{i = 1}^{3} ‖ {( {R}_{A} ( {x}_{i} - {x}_{c m} ) - ( {a}_{i} - {a}_{c m} ) ‖}^{2} , \qquad ( 9 )$$

where R_{A} is the 3×3 rotation matrix,

$${x}_{c m} = \frac{1}{3} {\sum }_{i} {x}_{i} , and {a}_{c m} = \frac{1}{3} {\sum }_{i}$$

aᵢ. Unfortunately, differentiating this equation is difficult because it contains the rotation matrix. When the rotation is infinitesimal, the rotation matrix R_{A} can be approximated by (I+ω_{A}×), where z× denotes the standard skew symmetric matrix of vector z. Then Equation (9) can be written as

$$\text{arg} {min}_{{ω}_{A}} {\sum }_{i = 1}^{3} {‖ ( I + {ω}_{A} \times ) ( {x}_{i} - {x}_{c m} ) - ( {a}_{i} - {a}_{c m} ) ‖}^{2} . \qquad ( 10 )$$

If we use the notations pᵢ=xᵢ/x_{cm} and qᵢ=aᵢ/a_{cm}, the above equation can be simplified into

$$\text{arg} {min}_{{ω}_{A}} {\sum }_{i = 1}^{3} {‖ {p}_{i} + {ω}_{A} \times {p}_{i} - {q}_{i} ‖}^{2} . \qquad ( 11 )$$

Equating the derivative of the objective function of Equation (11) to zero, we obtain

$$( {\sum }_{i} {p}_{i} \times {p}_{i} \times ) {ω}_{A} = - {\sum }_{i} {p}_{i} \times {q}_{i} . \qquad ( 12 )$$

Here, qᵢ and thus ω_{A} are functions of the displacement u_{A}. Differentiating both sides of Equation (12) with respect to u_{A} and evaluating the derivative for the undeformed state, we obtain the 3×9 Jacobian matrix

$$\frac{\partial {ϖ}_{A}}{\partial {u}_{A}} {\vert}_{0} = - {( {\sum }_{i} {p}_{i} \times {p}_{i} \times )}^{- 1} [ {p}_{1} \times \vert {p}_{2} \times \vert {p}_{3} \times ] . \qquad ( 13 )$$

Equation (13) is derived under the assumption that the deformation contains a small rotational component. The modal warping procedure introduced in Section 3.3 takes the approach of decomposing a large rotational deformation into a number of small rotational deformations so that the above result can be applied.

With the Jacobian given in Equation (13), we can approximate ω_{A}(u_{A}) with first-order Taylor expansion

$${ω}_{A} ( {u}_{A} ) = {ω}_{A} ( 0 ) + \frac{\partial {ϖ}_{A}}{\partial {u}_{A}} {\vert}_{0} {u}_{A} + O ( {u}_{A}^{2} ) . \qquad ( 14 )$$

Here ω_{A}(0) is zero because there is no rotation at the undeformed state. The above was the procedure to obtain the rotation vector of a triangle. We obtain the rotation vector of a mesh node by taking average of the rotation vectors of the triangles sharing the node.

Based on the above discussion, we can now assemble the Jacobians ∂ω_{A}=∂ω_{A} of all the triangles to form the global matrix W such that Wu gives the 3n-dimensional composite vector w. Finally, expanding u(t) with Equation (7) gives

w(t)≈WΦq\hat{=}Ψq(t). (15)

Both W and Φ are characterized by the thin shell at the undeformed state and are thus constant over time. Therefore we can precompute Ψ. The above equation shows that, as in the displacement (7), we can represent local rotations of mesh nodes in terms of q(t). We call Ψ the modal rotation matrix.

Integration of Rotational Parts

Equation (15) provides an efficient way to keep track of the rotations occurring at the shell nodes. However, such rotations are not yet reflected in the calculation of the displacement field u(t). Moreover, the results derived in Sections 3.1 and 3.2 hold only when rotational component of the deformation is moderately small. Both of these problems can be resolved by introducing a local frame to each mesh node.

We embed a local coordinate frame {i} at each node i such that at the initial state it is aligned with the global coordinate frame. We use the notation {i}(t) to refer to the local coordinate frame at time t. Let Ri(t) be the rotation matrix representing the orientation of {i}(t), and \dot{u}ᵢ^{L}(t)dt be the differential displacement of the i-th node at time t−dt measured from {i}(t−dt). Then, the finite displacement uᵢ(t) measured from the global coordinate frame can be calculated by

uᵢ(t)=∫₀^{t}Rᵢ(τ)\dot{u}ᵢ^{L}(τ)dτ. (16)

The above integration must be carried out for every node.

For the calculation of Equation (16), we need a new governing equation rather than Equation (6) which can be solved for UL, the generalized displacement vector measured in the time-varying local coordinate frames. By premultiplying R to both sides of (6) and making assumptions on commutativity in fine meshes and warped stiffness,

Mü^{L}+C\dot{u}^{L}+Ku^{L}=R^{T}F (17)

can be obtained, where K is K(u) in the undeformed state and R is a 3×3 block diagonal matrix constructed with Rᵢs.

Note that (1) the rotations that occurred over time at the mesh nodes are now reflected in the result of Equation (16), and (2) since it integrates small rotations, the equations derived in Sections 3.1 and 3.2 are applicable and can simulate large rotational deformation of shells.

Experiments

The proposed technique was implemented into an Autodesk MAYA plugin that runs in Microsoft Windows^{XP} environment. To obtain the m dominant eigenvalues of large sparse square matrices and corresponding eigenvectors, we used the built-in C++ math function eigs in MATLAB. The Jacobians of the energy functions were calculated symbolically with Maple. All experiments described in this section were performed on a PC with an Intel Pentium D 3.46 GHz processor, 2 GB memory, and an nVIDIA GeForce FX 7900 GTX graphics card. In all experiments, we fixed the time step size to h=1=30 second but we did not encounter any instability problem.

Large Mesh Test

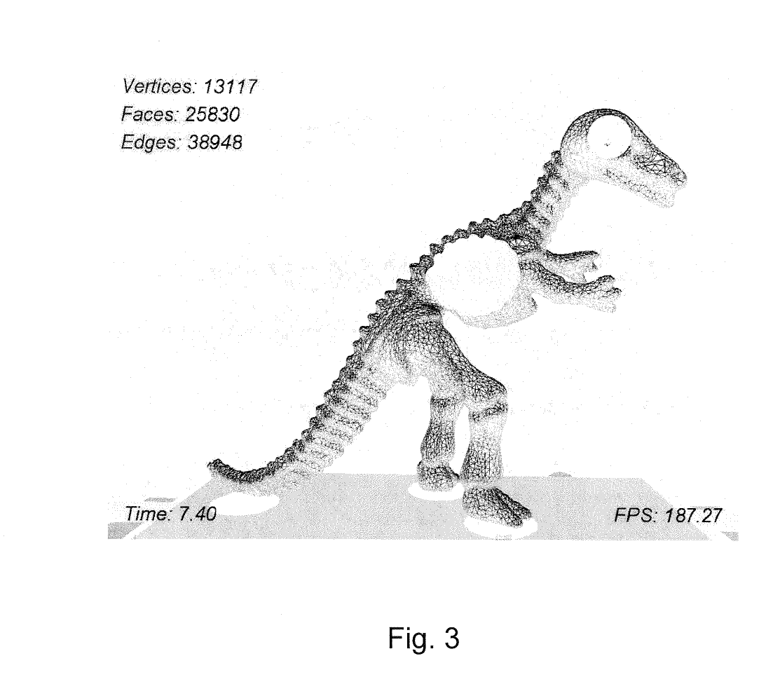

We simulated deformation of a 3D dinosaur shape shell which consists of 25,830 triangles (13,117 vertices and 38,948 edges) with the proposed technique. The simulation was done with four modes, which needed about 18 seconds of pre-computation. The model was excited by moving the basis with non-uniform velocities. FIG. 3 shows a snapshot taken during this experiment. The simulation ran at about 200 fps.

Flat Beam and V-Beam Test

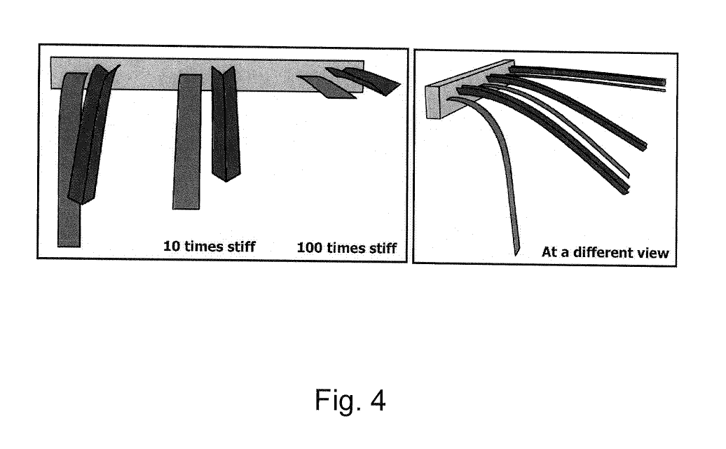

In this experiment, we tested the bending of flat beams and V-beams in the gravity field. FIG. 4 shows three pairs of results generated by the proposed technique using eight modes. Each pair consists of a flat beam and a V-beam of the same flexural stiffness for side-by-side comparison. From left to right, the pairs have increasing flexural stiffness; The middle pair is ten times as stiff as the leftmost one, and the rightmost pair is hundred times as stiff as the leftmost one. The figure shows that the V-beams have different bending behaviors from the flat beams, and the difference is more dramatic at smaller flexural stiffness.

Comparison to Other Methods

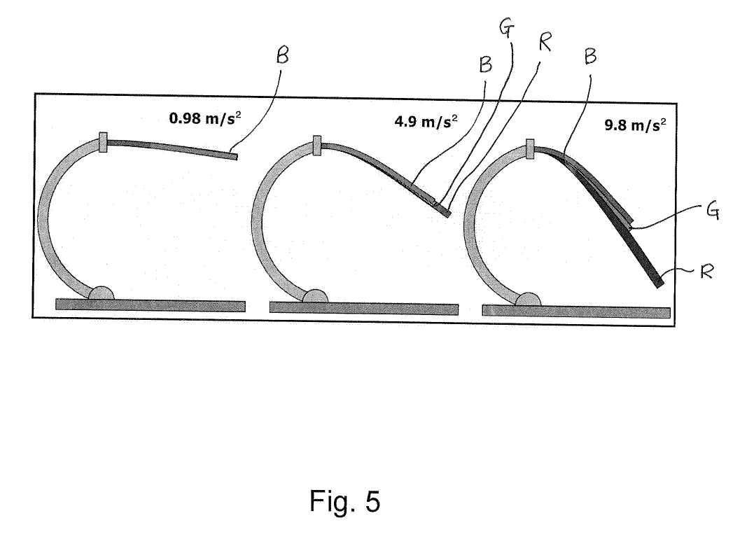

This experiment is to compare the results generated by linear modal analysis (LMA), modal warping for thin shells (MWTS), and nonlinear discrete shells (DS). We ran the three methods to deform a V-beam under different gravities. The simulations with LMA and MWTS were both performed using eight modes. For running DS, we employed explicit integration and used the time step size h= 1/30,000 second for numerical stability. FIG. 5 shows the snapshots taken at the equilibrium states.

A V-beam deformed by linear modal analysis (R), by modal warping for thin shells (B), and by discrete shells (G) under gravities of different magnitudes.

Error analysis of the V-beam is shown in FIG. 5; (a) The relative L₂ displacement field error, and (b) The area change with respect to the initial area. The area change of DS is almost zero so the curve is almost undistinguishable from the horizontal axis.

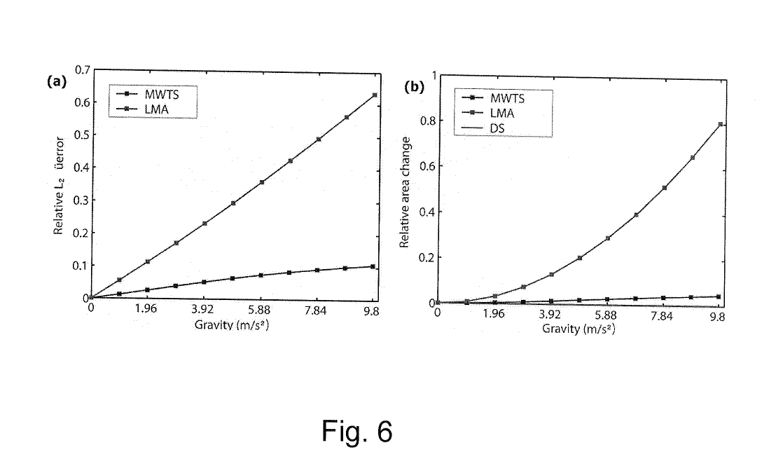

FIG. 6 (a) shows the plot of the relative L₂ displacement field error versus gravitational magnitude. We took the result produced by DS as the ground truth. The error of MWTS is smaller than that of LMA although both of them increase as the gravitational magnitude increases. FIG. 6 (b) is the plot of the relative area change with respect to the initial area. It shows that the area change in MWTS is almost identical to that in DS. Even though FIG. 6 (a) shows MWTS produces non-negligible L₂ displacement field errors, it was not easy to visually distinguish between the results produced with MWTS and DS, unless the results were seen overlayed. The area change of DS is almost zero so the curve is almost undistinguishable from the horizontal axis.

Manipulation Constraints

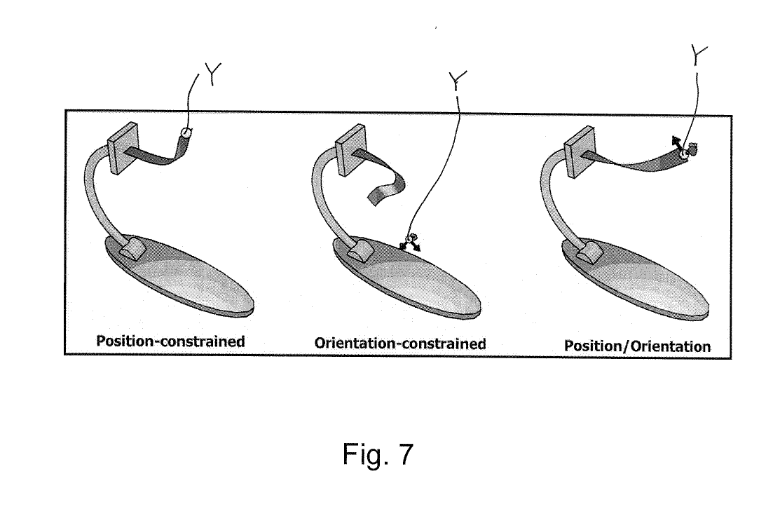

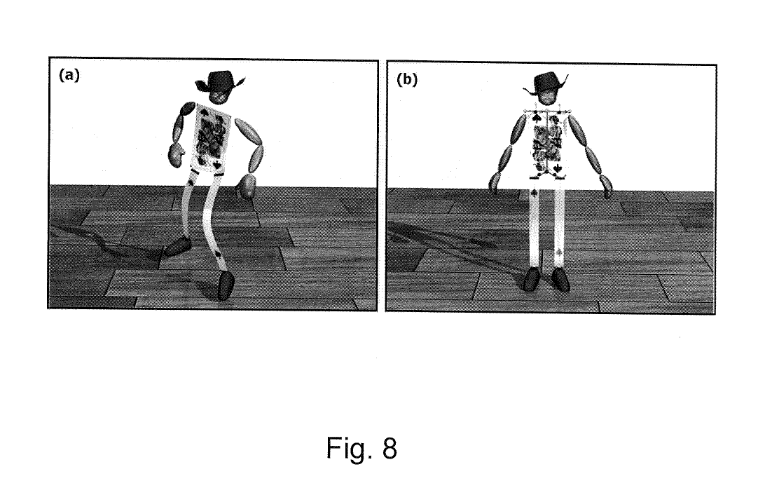

The manipulation constraints introduced in modal warping for 3D elastic solids can be applied to modal warping for thin shells. FIG. 7 shows the snapshots taken while a flat beam is manipulated with position/orientation constraints. The manipulation constraints can be used to animate a deformable character composed of thin shells. We simulated a character whose upper body and legs are made of thin shells (FIG. 8 (a)). As the character makes a dance motion, the shells were made to make passive dynamic deformations, excited by the gross body motion of the character. As shown in FIG. 8 (b), the shells were attached to the skeleton by position/orientation constraints (the RGB axes). The position constraints are represented by spheres (Y) and the orientation constraints are represented by RGB axes.

A flat beam manipulated with a position constraint (left), with an orientation constraint (middle), and with both position and orientation constraints (right). The position constraints are represented by spheres (Y) and the orientation constraints are represented by RGB axes.

Constraint-driven animation of a character consisting of four thin shells (the hat, body, and two legs).

Embodiments of the invention provide a real-time simulation technique for thin shells. We formulated dynamics of thin shells using the energy functions. Then, we made modifications to the modal warping technique, which was originally proposed for 3D elastic solids, so as to be used for simulating thin shells. The task involved development of a novel procedure to find the rotational components of deformation in terms of the modal amplitudes. Also, we showed that the manipulation constraints can be extended to thin shells. The proposed technique ran stably even when the time step size was fixed to h= 1/30 second, and produced visually convincing results.

Although the current implementation is done with the energy functions introduced in Section 2, it can work for any given dynamic formulation. We expect the proposed technique will prove useful in broad application areas, including computer games and character animation.

An aspect of the invention provide a method of simulation of a two-dimensional object, which comprises: providing information of motions of the two-dimensional object for which a graphical simulation is to be performed, wherein the object is represented by a 2-manifold triangular mesh including a plurality of nodes, wherein each of the plurality of nodes makes a displacement for a given time as the object experiences a deformation, wherein the displacement of each node is composed of a rotation of a local coordinate system and a local displacement of said node in the local coordinate system, wherein the local displacement defines a deviation of said node from a trajectory of the rotation of the local coordinate system; obtaining a modal amplitude of said node in the local coordinate for the given time, wherein the modal amplitude represents the local displacement in a modal space, in which the deformation of the object is described in terms of characteristic deformations (mode shape) in natural frequencies; obtaining a rotational vector of the local coordinate system by tracking orientation of the local coordinate frame associated with said node; and obtaining the displacement of said node for the given time using the rotational vector and the modal amplitude.

The object may comprise a thin flexible object, and providing may comprise mapping a plurality of positions of the object with the plurality of nodes.

Each of the plurality of nodes may have an equation of motion thereof, and the equation of motion of each node may be at least partially interdependent on motions of neighboring nodes, whereby equations of motion of the plurality of nodes form a group of equations.

The obtaining the modal amplitude may comprise solving the group of equations.

The group of equations may be adapted for a finite element model computation.

Motion of said node may be represented by a first equation of Mü(t)+C\dot{u}(t)+Ku(t)=F(t) wherein u(t) represents a displacement of said node, where M represents a mass of a portion of the object represented by said node, where C represents damping characteristics of said node, where K represents stiffness characteristics of said node, and where F represents external forces exerted to said node. The displacement u(t) may be represented using the modal amplitude and a modal displacement matrix associated with the first equation in the equation of u(t)=Φq(t), where Φ is the modal displacement matrix, and where q(t) is the modal amplitude of said node in the local coordinate system. The first motion equation may be converted to a second motion equation representing the motion of said node using the modal amplitude.

The rotational vector may be obtained using a global matrix of rotation and a modal displacement matrix associated with a group of equations representing motions of the plurality of nodes. The global matrix of rotation may represent rotations of the plurality of nodes, and each column of the modal displacement matrix may represent a corresponding mode shape.

The rotation vector may be obtained using the formula w(t)=WΦq(t), where W is the global matrix of rotation, Φ is the modal displacement matrix, and q(t) is the modal amplitude of said node in the local coordinate system.

The global matrix of rotation, W, may be obtained based on Jacobian of orientation of a triangle defined by said node and neighboring nodes. The orientation of the triangle may be obtained by a solution to

$$\text{arg} {min}_{{ω}_{A}} {\sum }_{i = 1}^{3} ‖ {( {R}_{A} ( {x}_{i} - {x}_{c m} ) - ( {a}_{i} - {a}_{c m} ) ‖}^{2} ,$$

where xᵢ represent the vertices in a undeformed state, aᵢ represent the position of the vertices after deformation, R_{A} is the 3×3 rotation matrix,

$${x}_{c m} = \frac{1}{3} {\sum }_{\underline{i}} {x}_{i} , and {a}_{c m} = \frac{1}{3} {\sum }_{\underline{i}} a .$$

The modal displacement matrix may be obtained by solving an eigenvalue problem for the group of equations.

The obtaining the rotation vector may comprise obtaining a rotation vector of a triangle before and after deformation defined by three nodes. The obtaining the rotation vector may comprise taking average of rotation vectors of a plurality of triangles sharing said node.

The method may further comprise obtaining the local displacement of said node in the local coordinate system using the modal amplitude.

The obtaining the displacement of said node for the given time may comprise adding the local displacement to the rotation vector of the local coordinate system.

The displacement of said node for the given time may be represented by an equation, u=\tilde{R}Φq, where u is the displacement of said node for the given time,

$$\tilde{R} is \frac{1}{t} {\int }_{0}^{t} R ( t ) d t ,$$

q is the modal amplitude of said node in the local coordinate, and Φ is a modal displacement matrix associated with a group of equations representing motions of the plurality of nodes, and each column of the modal displacement matrix may represent a corresponding mode shape.

The obtaining the displacement of said node may comprise integrating computation using the equation of

$$u = {\int }_{0}^{t} R ( t ) Φ \dot{q} ( t ) d t ,$$

where R(t) represents an orientation of a local coordinate of each node at time t, q is the modal amplitude of said node in the local coordinate, and Φ is a modal displacement matrix associated with a group of equations representing motions of the plurality of nodes, and each column of the modal displacement matrix may represent a corresponding mode shape.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method of simulation of a two-dimensional object, the method comprising:
providing information of motions of the two-dimensional object for which a graphical simulation is to be performed, wherein the object is represented by a 2-manifold triangular mesh including a plurality of nodes, wherein each of the plurality of nodes makes a displacement for a given time as the object experiences a deformation, wherein the displacement of each node is composed of a rotation of a local coordinate system and a local displacement of said node in the local coordinate system, wherein the local displacement defines a deviation of said node from a trajectory of the rotation of the local coordinate system;
obtaining a modal amplitude of said node in the local coordinate for the given time, wherein the modal amplitude represents the local displacement in a modal space, in which the deformation of the object is described in terms of characteristic deformations (mode shape) in natural frequencies;
obtaining a rotational vector of the local coordinate system by tracking orientation of the local coordinate frame associated with said node; and
obtaining the displacement of said node for the given time using the rotational vector and the modal amplitude.

2. The method of claim 0, wherein the object comprises a thin flexible object, and wherein providing comprises mapping a plurality of positions of the object with the plurality of nodes.

3. The method of claim 0, wherein each of the plurality of nodes has an equation of motion thereof, wherein the equation of motion of each node is at least partially interdependent on motions of neighboring nodes, whereby equations of motion of the plurality of nodes form a group of equations.

4. The method of claim 3, wherein obtaining the modal amplitude comprises solving the group of equations.

5. The method of claim 3, wherein the group of equations is adapted for a finite element model computation.

6. The method of claim 0, wherein motion of said node is represented by a first equation of Mü(t)+C\dot{u}(t)+Ku(t)=F(t) wherein u(t) represents a displacement of said node, wherein M represents a mass of a portion of the object represented by said node, wherein C represents damping characteristics of said node, wherein K represents stiffness characteristics of said node, and wherein F represents external forces exerted to said node.

7. The method of claim 6, wherein the displacement u(t) is represented using the modal amplitude and a modal displacement matrix associated with the first equation in the equation of u(t)=Φq(t), wherein Φ is the modal displacement matrix, and wherein q(t) is the modal amplitude of said node in the local coordinate system, wherein the first motion equation is converted to a second motion equation representing the motion of said node using the modal amplitude.

8. The method of claim 0, wherein the rotational vector is obtained using a global matrix of rotation and a modal displacement matrix associated with a group of equations representing motions of the plurality of nodes, wherein the global matrix of rotation represents rotations of the plurality of nodes, wherein each column of the modal displacement matrix represents a corresponding mode shape.

9. The method of claim 8, wherein the rotation vector is obtained using the formula w(t)=WΦq(t), wherein W is the global matrix of rotation, wherein Φ is the modal displacement matrix, and wherein q(t) is the modal amplitude of said node in the local coordinate system.

10. The method of claim 8, wherein the global matrix of rotation, W, is obtained based on Jacobian of orientation of a triangle defined by said node and neighboring nodes.

11. The method of claim 10, wherein the orientation of the triangle is obtained by a solution to
$$\text{arg} {min}_{{ω}_{A}} {\sum }_{i = 1}^{3} ‖ {( {R}_{A} ( {x}_{i} - {x}_{c m} ) - ( {a}_{i} - {a}_{c m} ) ‖}^{2} ,$$
wherein xᵢ represent the vertices in a undeformed state, aᵢ represent the position of the vertices after deformation, R_{A} is the 3×3 rotation matrix,
$${x}_{c m} = \frac{1}{3} {\sum }_{\underline{i}} {x}_{i} , and {a}_{c m} = \frac{1}{3} {\sum }_{\underline{i}} a .$$

12. The method of claim 8, wherein the modal displacement matrix is obtained by solving an eigenvalue problem for the group of equations.

13. The method of claim 0, wherein obtaining the rotation vector comprises obtaining a rotation vector of a triangle before and after deformation defined by three nodes.

14. The method of claim 13, wherein obtaining the rotation vector comprises taking average of rotation vectors of a plurality of triangles sharing said node.

15. The method of claim 0, further comprising obtaining the local displacement of said node in the local coordinate system using the modal amplitude.

16. The method of claim 0, wherein obtaining the displacement of said node for the given time comprises adding the local displacement to the rotation vector of the local coordinate system.

17. The method of claim 0, wherein the displacement of said node for the given time is represented by an equation, u=\tilde{R}Φq, wherein u is the displacement of said node for the given time, wherein \tilde{R} is
$$\frac{1}{t} {\int }_{0}^{t} R ( t ) d t ,$$
wherein q is the modal amplitude of said node in the local coordinate, wherein Φ is a modal displacement matrix associated with a group of equations representing motions of the plurality of nodes, wherein each column of the modal displacement matrix represents a corresponding mode shape.

18. The method of claim 0, wherein obtaining the displacement of said node comprises integrating computation using the equation of
$$u = {\int }_{0}^{t} R ( t ) Φ \dot{q} ( t ) d t ,$$
wherein R(t) represents an orientation of a local coordinate of each node at time t, wherein q is the modal amplitude of said node in the local coordinate, wherein Φ is a modal displacement matrix associated with a group of equations representing motions of the plurality of nodes, wherein each column of the modal displacement matrix represents a corresponding mode shape.
